(19) United States
(12) Patent Application Publication
(10) Pub. No.: US 2020/0020497 A1
(43) Pub. Date: Jan. 16, 2020

(54) ASSEMBLED MEMBER AND ELECTROMAGNETIC RELAY

(71) Applicant: Fujitsu Component Limited, Tokyo (JP)

(72) Inventors: Ying Li, Tokyo (JP); Masahiro Kaneko, Tokyo (JP); Nobuo Yatsu, Tokyo (JP); Yayoi Tokuhara, Tokyo (JP); Kohei Takahashi, Tokyo (JP); Katsuaki Koshimura, Tokyo (JP); Rie Tsudome, Tokyo (JP); Miki Kitahara, Tokyo (JP)

(21) Appl. No.: 16/508,545

(22) Filed: Jul. 11, 2019

(30) Foreign Application Priority Data
Jul. 13, 2018 (JP) 2018-133481

(51) Int. Cl. H01H 50/36; H01H 50/14; H01H 50/02

(52) U.S. Cl. CPC H01H 50/36; H01H 50/02; H01H 50/14

(57) ABSTRACT

An assembled member including a press-fit part, a molded part having a hole into which the press-fit part is press-fit, and a lid provided on the press-fit part or the hole so as to form a closed space for holding shavings between the hole and the press-fit part when the press-fit part is press-fit into the hole.

### CROSS-REFERENCE TO RELATED APPLICATIONS

This application is based upon and claims the benefit of priority of the prior Japanese Patent Application No. 2018-133481, filed Jul. 13, 2018, the entire contents of which are incorporated herein by reference.

### TECHNICAL FIELD

The present invention relates to an assembled member. The present invention also relates to an electromagnetic relay.

### BACKGROUND

Electromagnetic relays are assembled by press-fitting a fixed contact spring and a movable contact spring into a base provided as a molded part. When these parts are press-fit into the molded part during the assembly of electromagnetic relays, the molded part may be scrapes by the press-fitted parts, generating mold shavings (also referred to as shavings). To remove shavings, the shavings are blown away by air-blowing after the parts have been press-fit into the molded part.

However, when removing shavings with air-blowing, the shavings may remain inside electronic components, and it is difficult to completely remove the shavings. Therefore, shavings remaining inside the electronic components may move due to vibrations during transportation or operation of the electromagnetic relay, which may affect the contact of a contact point. JP 2015-127997A, JP H5-182575A, JP 3468552B or JP 5251616B disclose techniques for preventing contact failures caused by shavings and the generation of shavings.

### SUMMARY

An object of one aspect is to provide an assembled member that prevents the scattering of shavings generated during the press-fitting of press-fit parts into a molded part. An object of another aspect is to provide an electromagnetic relay that prevents the scattering of shavings generated during the press-fitting of press-fit parts such as a fixed contact spring into a base, which is a molded part.

One aspect is an assembled member including a press-fit part, a molded part provided with a hole in which the press-fit part is press-fit, and a lid which is provided on the press-fit part or the hole and forms a closed space between the hole and the press-fit part when the press-fit part is press-fit into the hole.

Another aspect is an electromagnetic relay including a base made of resin and provided with a hole, an electromagnet mounted on the base, a contact spring which is press-fit in the hole and which has a contact operating to open or close due to the electromagnet, and a lid which is provided on either one of the hole and the contact spring and which forms a closed space between the contact spring and the hole when the contact spring is press-fit into the hole.

In the assembled member according to one aspect, the scattering of shavings generated during the press-fitting of the press-fit part into the molded part is prevented. In the electromagnetic relay according to the other aspect, the scattering of shavings generated during the press-fitting of the contact spring into the hole of the base is prevented.

### BRIEF DESCRIPTION OF THE DRAWINGS

FIG. 1 is a perspective view illustrating an electromagnetic relay according to a first embodiment.

FIG. 2A is a perspective view of a fixed contact spring.

FIG. 2B is a perspective view of a movable contact spring.

FIG. 3 is an exploded perspective view illustrating a state before a fixed contact spring and a movable contact spring are mounted on a base.

FIG. 4A is a side view illustrating an electromagnetic relay.

FIG. 4B is an enlarged view of a part B of FIG. 4A.

FIG. 5 is a perspective view illustrating an electromagnetic relay according to a second embodiment.

FIG. 6A is an exploded perspective view illustrating a state before a fixed contact spring is mounted on a base.

FIG. 6B is a perspective view illustrating a state after the fixed contact spring is mounted on the base.

FIG. 7 is a partial enlarged cross-sectional view taken along line VII-VII of FIG. 6B.

FIG. 8 is an exploded perspective view illustrating a state before a fixed contact spring is mounted on a base according to a modified example.

FIG. 9A is a perspective view of a fixed contact spring according to another modified example.

FIG. 9B is an enlarged perspective view of a part B of FIG. 9A.

FIG. 10 is a partial enlarged cross-sectional view illustrating a state in which the fixed contact spring is mounted on the base.

FIG. 11 illustrates a third embodiment, and is an exploded perspective view illustrating a state before a movable contact spring is mounted on a base.

FIG. 12 illustrates a front view of the movable contact spring and a cross-sectional view of the base.

FIG. 13A is a partial enlarged cross-sectional view illustrating a state in which the movable contact spring and the base of FIG. 12 are mounted together.

FIG. 13B is a cross-sectional view taken along line B-B of FIG. 13A.

FIG. 14 illustrates a fourth embodiment, and is an exploded perspective view illustrating a state before a fixed contact spring is mounted on a base.

FIG. 15 is a side view illustrating a state after a fixed contact spring is mounted on a base.

FIG. 16 is a partial enlarged cross-sectional view of FIG. 15.

FIG. 17 is an enlarged plan view of a lid.

FIG. 18A is a partial enlarged cross-sectional view illustrating a state before a fixed contact spring is mounted on a base.

FIG. 18B is a partial enlarged cross-sectional view illustrating a state after a fixed contact spring is mounted on a base.

FIG. 19A illustrates a fifth embodiment, and is a perspective view illustrating a state after a yoke is mounted on a base.

FIG. 19B is a perspective view of a yoke.

FIG. 20A is a cross-sectional view illustrating a state after a yoke is mounted on a base.

FIG. 20B is a cross-sectional view illustrating a modified example of a yoke and a base.

### DETAILED DESCRIPTION

The embodiments of the present application will be described in detail based on specific examples with reference to the accompanying drawings. In the embodiments, the same or similar elements are indicated by common reference numerals. The scales of the drawings have been appropriately changed in order to facilitate understanding.

### First Embodiment

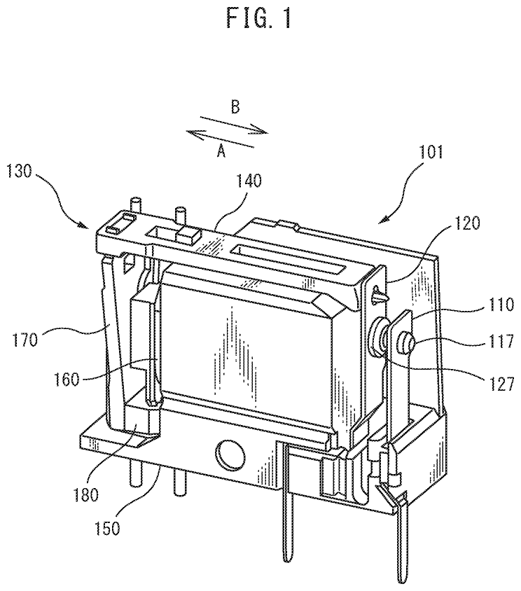

FIGS. 1 to 4B illustrate an electromagnetic relay 101 according to a first embodiment of the present invention. The electromagnetic relay 101 includes a fixed contact spring 110 and a movable contact spring 120, which are press-fit parts; an electromagnet 130; and a base 150 that is a molded part provided with holes 115 and 125 into which the press-fit parts are press-fit. Moreover, though not illustrated in FIG. 1, the electromagnetic relay 101 includes a cover which houses the electromagnet 130, the fixed contact spring 110, and the movable contact spring 120.

The base 150 is a member where the electromagnet 130, the fixed contact spring 110, and the movable contact spring 120 are mounted. The electromagnet 130 is fixed to the base 150. The fixed contact spring 110, the movable contact spring 120, and the base 150 constitute an assembled member according to one embodiment of the present invention.

The electromagnet 130 includes a coil 160, a core (not illustrated) in the interior of the coil 160, and a yoke 180 mounted on the core. An armature 170 is moved by magnetizing or demagnetizing the core, and a card 140 coupled to the armature 170 moves in direction A and direction B of FIG. 1. The card 140 is coupled to the movable contact spring 120, and moves so as to move a movable contact 127 of the movable contact spring 120 into contact with or away from a fixed contact 117 of the fixed contact spring 110.

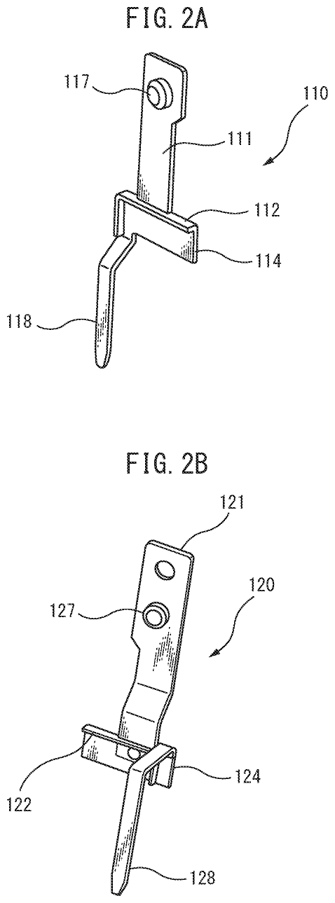

FIG. 2A illustrates the fixed contact spring 110. The fixed contact spring 110 is a metallic member. The fixed contact spring 110 includes a body 111, the fixed contact 117 attached to the upper end of the body 111, a support 114 that is provided on the lower end of the body 111 and supports the body 111, a lid 112 provided on the support 114, and a terminal 118 extending from the bottom of the support 114.

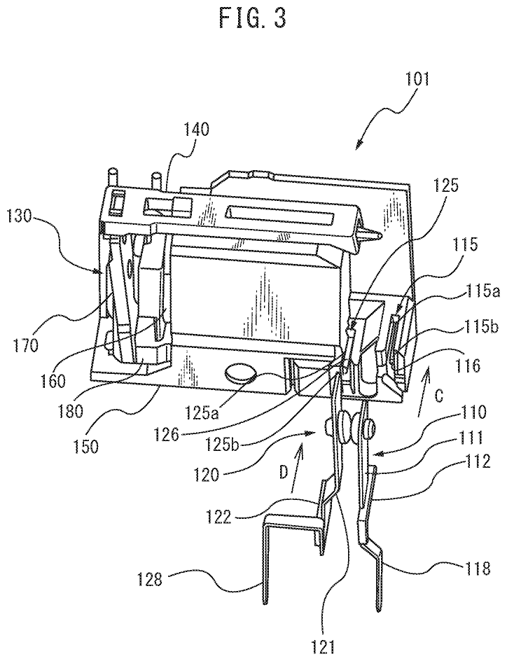

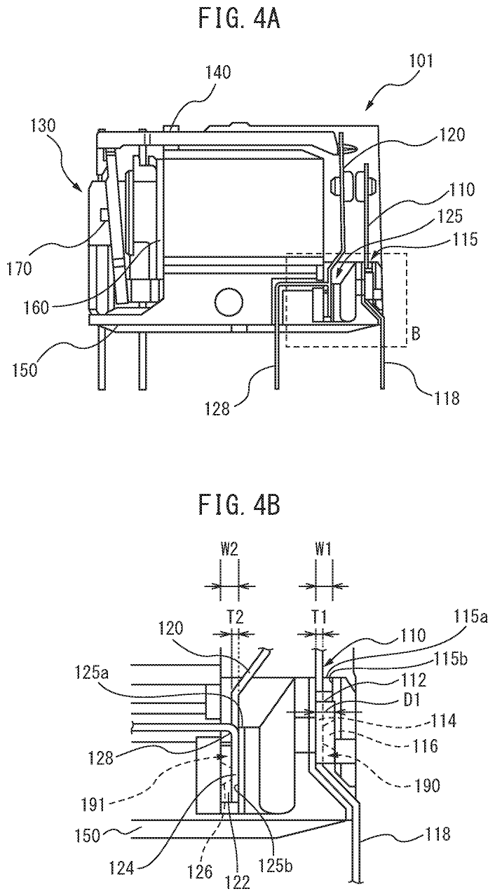

As illustrated in FIGS. 3 to 4B, the hole 115 includes an opening 115a that is opened upward and an opening 115b that is laterally opened. The fixed contact spring 110 is press-fit in direction C from the opening 115b into the hole 115, as illustrated in FIG. 3, so that the fixed contact spring 110 is mounted on the base 150. After the fixed contact spring 110 is attached to the base 150, the body 111 protrudes from the opening 115a.

As illustrated in FIG. 4B, the openings 115a and 115b have a width W1 that is greater than a thickness T1 of the support 114, facilitating the insertion of the fixed contact spring 110. A protrusion 116 which protrudes from the side wall of the hole 115 is formed in the interior of the hole 115, as illustrated in FIGS. 3 and 4B. After the fixed contact spring 110 has been press-fit into the hole 115, the support 114 is supported by the protrusion 116 and the fixed contact spring 110 is fixed to the base 150. When the fixed contact spring 110 is press-fit, the protrusion 116 made of resin may be partially scraped by the support 114, whereby shavings may be generated.

As illustrated in FIG. 4B, when the fixed contact spring 110 is press-fit into the hole 115, the lid 112 forms a closed space 190 that holds shavings between the hole 115 and the fixed contact spring 110. The lid 112 is a flange formed in a side part of the support 114 so as to close a gap between the hole 115 and the fixed contact spring 110 along the openings 115a and 115b. The lid 112 protrudes from the side surface along the edge of the support 114 so as to abut on the outer surface of the base 150 outside the hole 115. A width D1 of the lid 112 is greater than the width W1 of the openings 115a and 115b. The openings 115a and 115b are covered with the lid 112, so that shavings generated in the press-fitting of the fixed contact spring 110 into the hole 115 can be held in the closed space 190 between the hole 115 and the lid 112. Shavings are not moved or scattered from the hole 115 to the outside, thereby preventing shavings from being moved by, for example, vibrations during transportation. This eliminates the possibility of influence on the contact of a contact point. Note that the closed space may not be a completely closed space but means a space for preventing shavings from moving out of the space, and may have a gap as long as the passage of shavings is prevented.

FIG. 2B illustrates the movable contact spring 120. The movable contact spring 120 includes a body 121 having the movable contact 127 that comes in contact with the fixed contact 117, a support 124 joined to the body 121 by caulking, a terminal 128 extending from the support 124, and a lid 122 formed on one side of the support 124. Like the fixed contact spring 110, the movable contact spring 120 is press-fit into the hole 125 in direction D as illustrated in FIG. 3, so that the movable contact spring 120 is mounted on the base 150. As illustrated in FIGS. 3 to 4B, the hole 125 includes an opening 125a that is opened upward and an opening 125b that is laterally opened. The support 124 is inserted from the opening 125b. After the movable contact spring 120 has been mounted on the base 150, the body 121 protrudes from the opening 125a. As illustrated in FIG. 4B, the hole 125 has a width W2 that is greater than a thickness T2 of the support 124. The support 124 is supported by a protrusion 126 that protrudes from the inner wall of the hole 125, thereby fixing the movable contact spring 120. When the support 124 is press-fit, the support may scrape a part of the protrusion 126, whereby shavings may be generated.

As illustrated in FIG. 4B, the lid 122 forms a closed space 191 that holds the shavings between the hole 125 and the movable contact spring 120 when the movable contact spring 120 is press-fit into the hole 125. The lid 122 includes a flange formed along an edge of the support 124 so as to close a space between the hole 125 and the movable contact spring 120, and a protrusion formed on one side. The lid 122 protrudes from the side of the support 124 so as to abut on the inner surface of the hole 125 adjacent to the openings 125a and 125b. After the movable contact spring 120 has been press-fit into the hole 125, shavings are held in the closed space 191, thereby preventing the shavings from moving or scattering out of the hole 125. This prevents the shavings from being moved by, for example, vibrations during transportation, eliminating the possibility of influence on the contact of the contact point.

The lid 112 and the lid 122 may be formed by, for example, press-bending or insert-molding.

### Second Embodiment

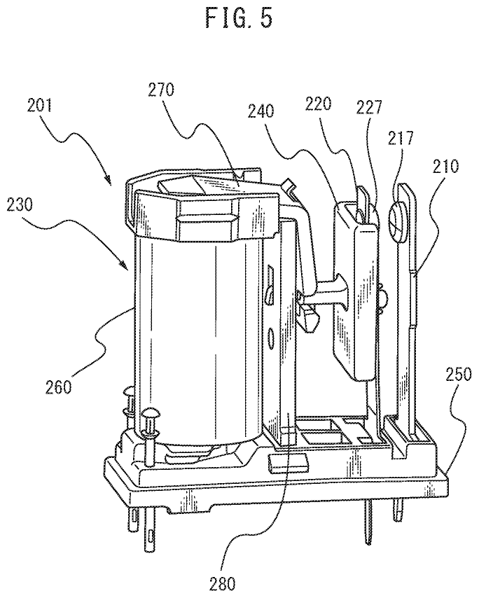

FIG. 5 illustrates an electromagnetic relay 201 according to a second embodiment of the present invention. The electromagnetic relay 201 includes a base 250 as a molded part; and a yoke 280 (a component of the electromagnet 230), a fixed contact spring 210 and a movable contact spring 220, which are press-fit parts. The electromagnet 230 includes a coil 260, a core (not illustrated) inside the coil 260, and the yoke 280 mounted on the core. Though not illustrated in FIG. 5, the electromagnetic relay 201 further includes a cover which houses the electromagnet 230, the fixed contact spring 210 and the movable contact spring 220. An armature 270 is moved by the magnetizing the electromagnet 230, and the movement of the armature 270 is transmitted to the movable contact spring 220 via a card 240, whereby the movable contact 227 contacts the fixed contact 217.

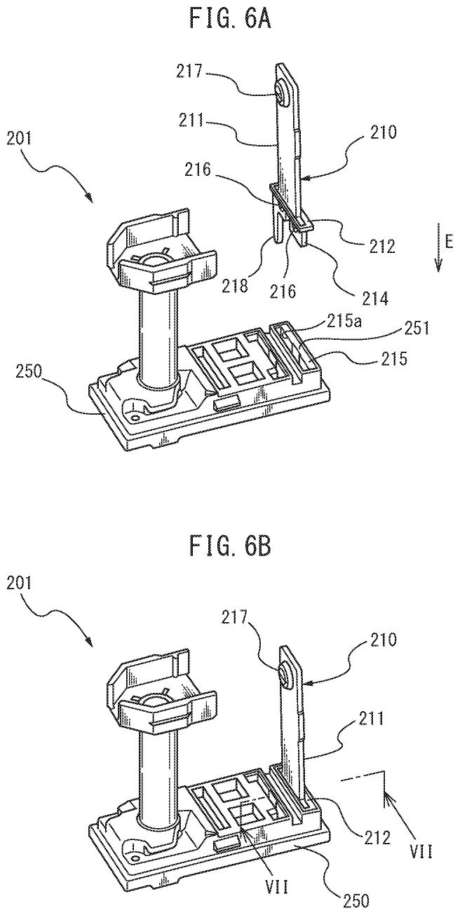

As illustrated in FIG. 6A, the fixed contact spring 210 includes a body 211, the fixed contact 217 placed on the upper end of the body 211, a support 214 placed on the lower end of the body 211, a terminal 218 extending from the bottom of the support 214, and a lid 212. The support 214 has protrusions 216 that protrude from one side of the support 214 so as to contact the interior of a hole 215 formed on the base 250, which will be described later. The fixed contact spring 210 is fixed to the base 250 by the protrusions 216. The fixed contact spring 210 and the base 250 constitute an assembled member according to another embodiment of the present invention.

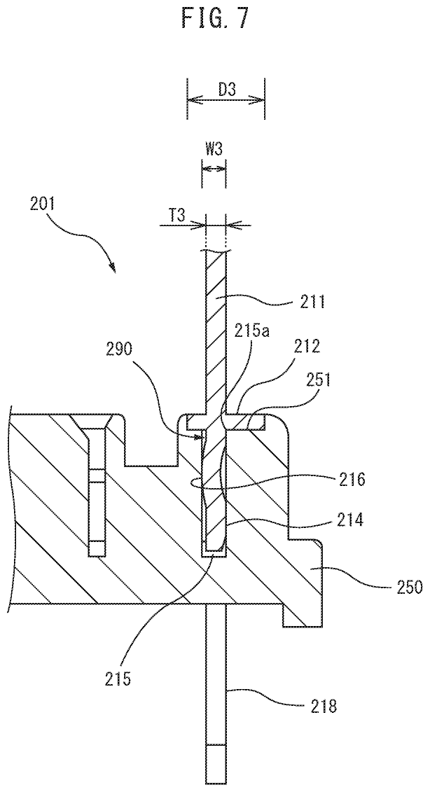

When the fixed contact spring 210 is mounted on the base 250, the support 214 is press-fit into the hole 215 in direction E in FIG. 6A. At this time, the protrusions 216 of the metallic support 214 may partially scrape the inner surface of the resin hole 215, whereby shavings may be generated. FIG. 6B illustrates a state after the fixed contact spring 210 has been mounted on the base 250. FIG. 7 is a partial enlarged cross-sectional view taken along line VII-VII of FIG. 6B. As illustrated in FIG. 7, the hole 215 has a width W3 which is greater than the thickness T3 of the support 214 of the fixed contact spring 210.

As illustrated in FIG. 7, the lid 212 forms a closed space 290 for holding shavings between the hole 215 and the fixed contact spring 210 when the support 214 is press-fit into the hole 215. The lid 212 is a flange provided along the entirety of the side of the support 214 so as to close a gap between the hole 215 and the fixed contact spring 210 along the opening 215a of the hole 215. The lid 212 is housed in a recess 251 provided in the base 250 outside the hole 215. The lid 212 has a width D3 that is greater than a width W3 of the hole 215. Shavings generated during press fitting are held in the closed space 290 by the lid 212. Shavings are not moved or scattered from the closed space 290 to the outside. Thus, the shavings are prevented from moving in response to, for example, vibrations during transportation, eliminating the possibility of influence on the contact of a contact point. Note that a through-hole (not shown) is formed at the bottom of the hole 215 so as to allow the terminal 218 to protrude from the bottom of the base 250.

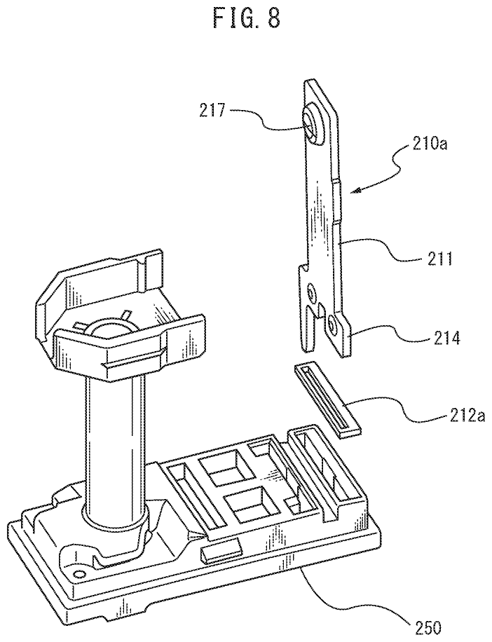

The lid 212 may be formed by integral molding with the body 211. On the other hand, a lid 212a may be formed as a part which is separate from the body 211 and the support 214 as illustrated in FIG. 8. The lid 212 and the lid 212a may be produced from a material such as a resin, rubber, or metal.

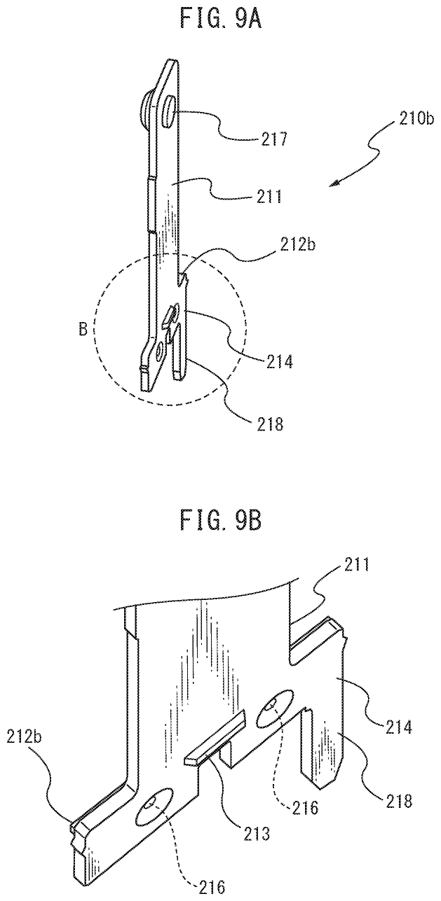

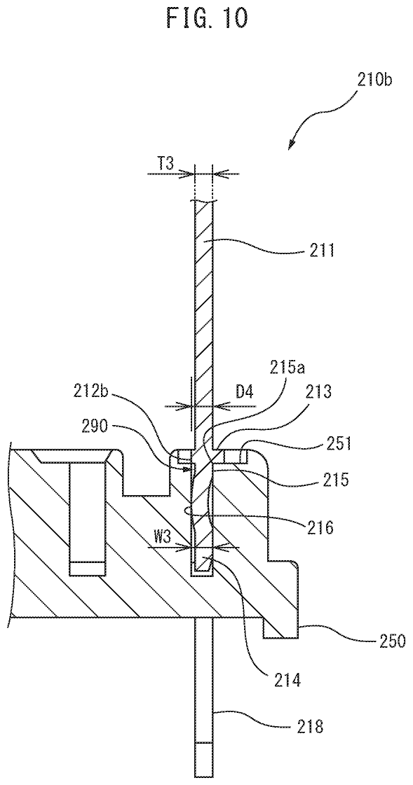

FIGS. 9A and 9B illustrate another example of a fixed contact spring 210b of the second embodiment. The fixed contact spring 210b includes a body 211; a fixed contact 217; a support 214; a terminal 218; and protrusions 216 and a lid 212b, which are formed on a side surface of the support 214. The lid 212b is formed above the protrusions 216 so as to close a gap between the hole 215 and the fixed contact spring 210b along the opening 215a of the hole 215. As illustrated in FIG. 10, a width D4, which is the sum of the width of the lid 212b and the thickness T3 of the support 214, is substantially equal to the width W3 of the hole 215. Shavings are held in the closed space 290 by the lid 212b.

The fixed contact spring 210b further includes a locking part 213 that protrudes on the side of the support 214 opposite the lid 212b so as to prevent the support 214 from being excessively inserted into the hole 215. The locking part 213 abuts the recess 251 of the base 250 outside the opening 215a of the hole 215, whereby the fixed contact spring 210b stops at a predetermined position.

### Third Embodiment

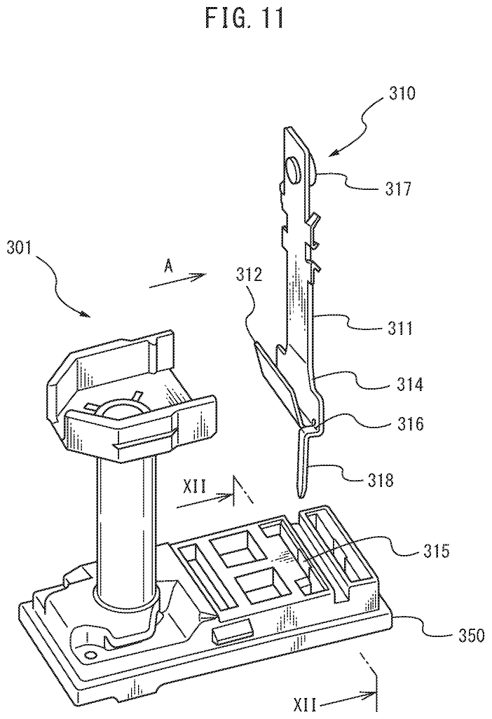

FIG. 11 illustrates a base 350 and a movable contact spring 310 of an electromagnetic relay 301 according to a third embodiment of the present invention. The movable contact spring 310 is a metallic press-fit part, and the base 350 is a resinous molded part having a hole 315 into which the movable contact spring 310 is press-fit. The electromagnet and fixed contact spring of the electromagnetic relay 301 are identical to the electromagnet 230 and the fixed contact spring 210 of the second embodiment, and an explanation thereof has been omitted.

The movable contact spring 310 includes a body 311, a movable contact 317 mounted on the upper end of the body 311, a support 314 provided on the lower end of the body 311, and a terminal 318 extending from the support 314. The movable contact spring 310 further includes a lid 312 that is bent upwards from the bottom of the support 314. The movable spring 310 and the base 350 constituted an assembled member according to a further embodiment of the present invention.

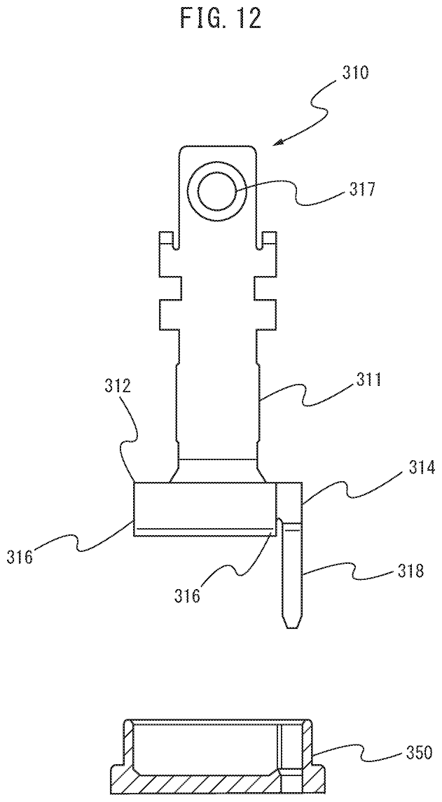

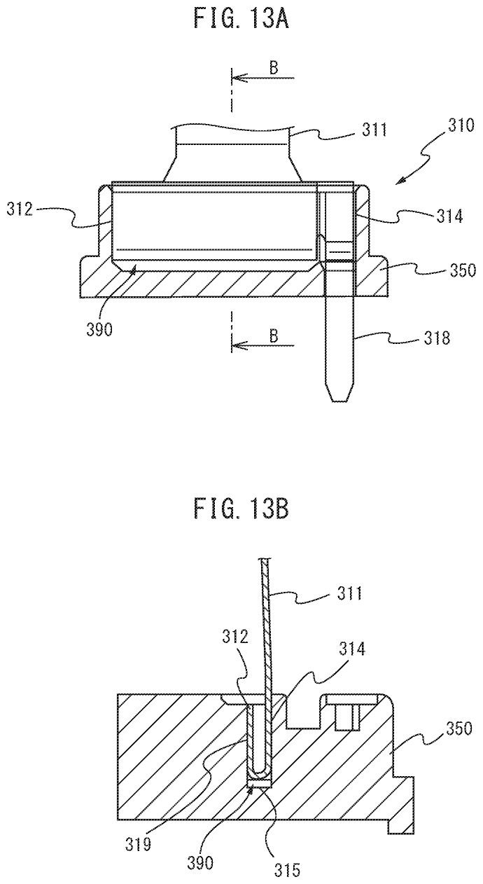

FIG. 12 illustrates a front view of the movable contact spring 310 as viewed from direction A of FIG. 11, and a cross-sectional view of the base 350 taken along line XII-XII of FIG. 11. As illustrated in FIGS. 12 to 13B, the lid 312 is a pressing piece that is elastically deformed into contact with an inner wall 319 of a hole 315 when the support 314 is press-fit into the hole 315. The lid 312 has a curved bottom and is U-shaped with the support 314 in cross section.

As illustrated in FIG. 12, a protrusion 316 is provided so as to laterally protrude at a joint between the support 314 and the lid 312. The protrusion 316 protrudes on both ends of the joint and contacts the inner wall of the hole 315 when the support 314 is press-fit into the hole 315. Though the movable contact spring 310 is fixed to the base 350 by the protrusion 316, since the protrusion 316 scrapes the inner wall of the hole 315, shavings may be generated. As illustrated in FIGS. 13A and 13B, when the support 314 is press-fit into the hole 315, the lid 312 and the support 314 are pressed against the inner wall of the hole 315 by the elastic deformation of the lid 312 in the hole 315, and a closed space 390 is formed between the hole 315 and the movable contact spring 310. Thus, the lid 312 holds the shavings in the closed space 390, whereby scattering of the shavings outside the hole 315 is prevented.

### Fourth Embodiment

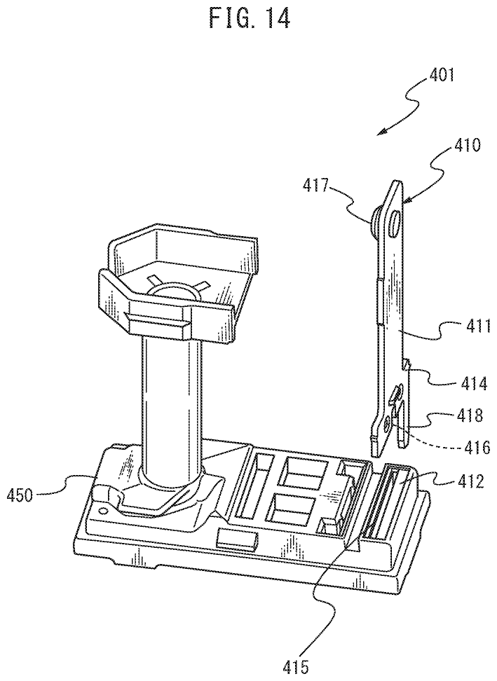

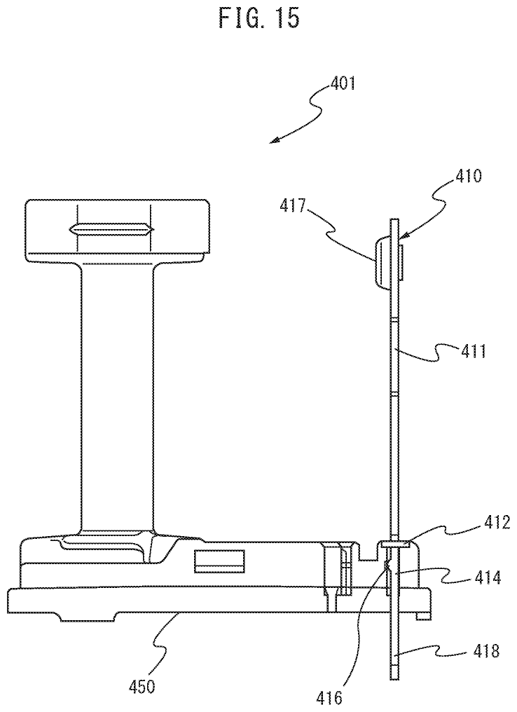

FIGS. 14 and 15 illustrate a base 450 and a fixed contact spring 410 in an electromagnetic relay 401 according to a fourth embodiment of the present invention. The fixed contact spring 410 is a metallic press-fit part, and the base 450 is a resinous molded part having a hole 415 into which the fixed contact spring 410 is press-fit. The electromagnet and the movable contact spring of the electromagnetic relay 401 are identical to the electromagnet 230 and movable contact spring 220 of the second embodiment, and an explanation thereof has been omitted.

The fixed contact spring 410 includes a body 411, a fixed contact 417 mounted on the upper end of the body 411, a support 414 provided on the lower end of the body 411, a terminal 418 extending from the support 414, and protrusions 416 that protrude from a side surface of the support 414. The fixed contact spring 410 is fixed to the base 450 by the protrusions 416. In the electromagnetic relay 401, a lid 412 is provided on the base 450. The fixed contact spring 410 and the base 450 constitute an assembled member according to yet another embodiment.

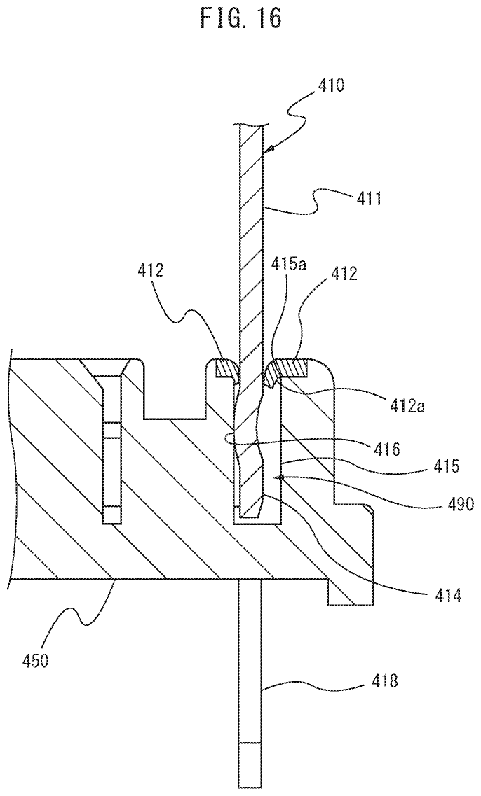

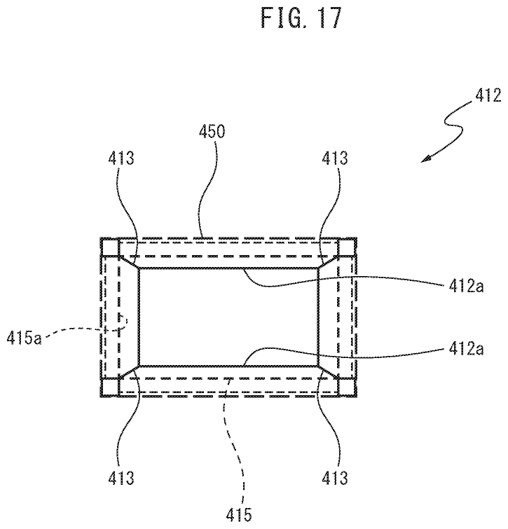

As illustrated in FIGS. 15 and 16, the lid 412 is an elastically deformable tongue member that is around outside the hole 415 and extends toward the inside of the opening 415a of the hole 415. As illustrated in FIG. 17, cuts 413 are formed on the four corners of the lid 412. Thus, when the support 414 is press-fit into the hole 415, as illustrated in FIG. 16, an inner end 412a of the lid 412 is elastically deformed so as to bend downward, whereby the end 412a abuts on the support 414, which forms a closed space 490 between the hole 415 and the fixed contact spring 410. The lid 412 holds the shavings in the closed space 490, which are generated by the scraping of the protrusions 416 against the inner surface of the hole 415 when the fixed contact spring 410 is press-fit into the hole 415, whereby scattering of the shavings to the outside of the hole 415 is prevented.

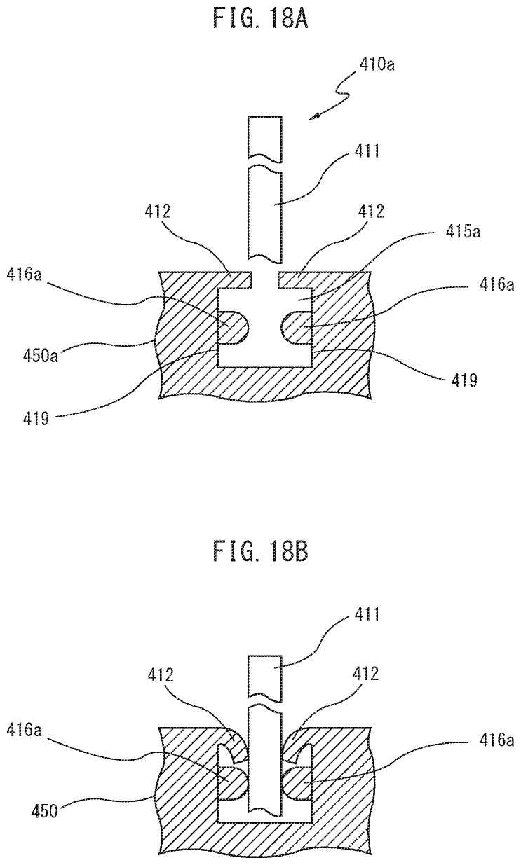

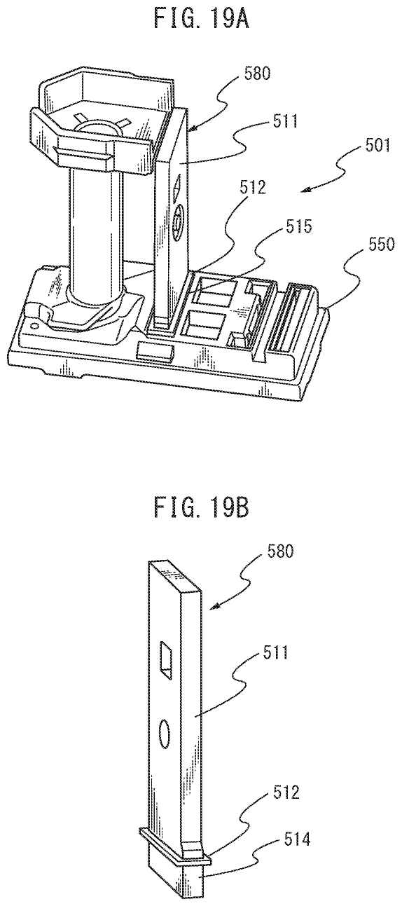

FIGS. 18A and 18B illustrate a fixed contact spring 410a and a base 450a as another modified example. In this modified example, protrusions 416a which fix the fixed contact spring 410a to the base 450a are provided so as to protrude from an inner wall 419 of a hole 415a. When the support 414 illustrated in FIG. 19B is press-fit into the hole 415a, the lid 412 forms the closed space 490 between the hole 415 and the fixed contact spring 410a, thereby preventing the shavings generated by the scraping of protrusions 416a by the support 414 from scattering to the outside.

### Fifth Embodiment

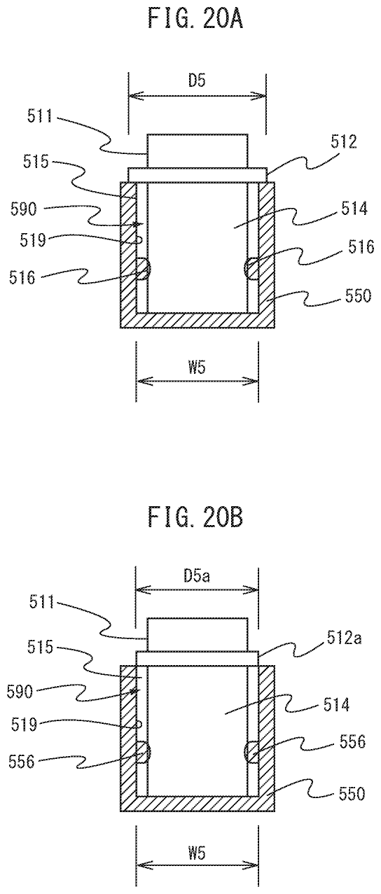

FIGS. 19A to 20B illustrate a base 550 and a yoke 580 of an electromagnetic relay 501 according to a fifth embodiment of the present invention. The base 550 is a resinous molded part and the yoke 580 is a metallic press-fit part. The fixed contact spring and movable contact spring of the electromagnetic relay 501 are identical to the fixed contact spring 210 and the movable contact spring 220 of the second embodiment, and thus, an explanation thereof has been omitted.

As illustrated in FIG. 19B, the yoke 580 includes a body 511, a support 514 provided on the lower end of the body 511, and a lid 512. The base 550 has a hole 515 in which the yoke 580 is press-fit. The yoke 580 and the base 550 constituted an assembled member according to yet another embodiment of the present invention. As illustrated in FIG. 20A, an inner wall 519 of the hole 515 has protrusions 516 that protrude from the inner wall 519. The support 514 is press-fit into the hole 515 and is supported by the protrusions 516, whereby the yoke 580 is fixed to the base 550. The protrusions 516 are made of resin. The protrusions 516 may be scraped by the metallic support 514, whereby shavings may be generated when the yoke 580 is press-fit. The lid 512 provided on the yoke 580 has a flange formed along the shape of the opening of the hole 515. The flange abuts on the outer surface of the base 550 outside the hole 515. As illustrated in FIG. 20A, the lid 512 has a width D5 that is greater than a width W5 of the hole 515. Thus, when the yoke 580 is mounted on the base 550, the lid 512 forms a closed space 590 between the hole 515 and the yoke 580, and the generated shavings are held in the closed space 590. This prevents shavings from moving and scattering out of the hole 515. Thus, the shavings are prevented from moving in response to, for example, vibrations during transportation, eliminating the possibility of influence on the contact of a contact point.

As illustrated in FIG. 20B, the width W5 of the hole 515 may be substantially equal to a width D5a of the lid 512. By forming the closed space 590 between the hole 515 and the lid 512, shavings generated by press-fitting are held in the closed space 590 and are prevented from moving and scattering out of the hole 515.

1. An assembled member comprising:
a press-fit part;
a molded part provided with a hole in which the press-fit part is press-fit; and
a lid which is provided on at least either one of the press-fit part and the hole and which forms a closed space between the hole and the press-fit part when the press-fit part is press-fit into the hole.

2. The assembled member according to claim 1, wherein the lid includes a flange which is provided on a side of the press-fit part so as to close a gap between the hole and the press-fit part.

3. The assembled member according to claim 1, wherein the lid is a pressing piece which is provided on the press-fit part and which is elastically deformed in the hole so as to abut on a surface defining the hole when the press-fit part is press-fit into the hole.

4. The assembled member according to claim 1, wherein the lid is a tongue member which is provided so as to extend from an outside to inside of an opening of the hole and which is elastically deformed so as to abut on the press-fit part when the press-fit part is press-fit into the hole.

5. An electromagnetic relay comprising:
a base made of resin and provided with a hole;
an electromagnet mounted on the base;
a contact spring which is press-fit in the hole and which has a contact operating to open or close due to the electromagnet; and
a lid which is provided on either one of the hole and the contact spring and which forms a closed space between the contact spring and the hole when the contact spring is press-fit into the hole.
